(19) United States
(12) Patent Application Publication
(10) Pub. No.: US 2007/0240571 A1
(43) Pub. Date: Oct. 18, 2007

(54) Device for Cleaning of an Air Stream

(76) Inventor: Andrzej Loreth, Akersberga (SE)

Correspondence Address: YOUNG & THOMPSON, 745 SOUTH 23RD STREET, 2ND FLOOR, ARLINGTON, VA, 22202, US

(21) Appl. No.: 10/575,448

(22) PCT Filed: Oct. 13, 2004
(86) PCT No.: PCT/SE04/01469

§ 371 Date: Feb. 22, 2007

(30) Foreign Application Priority Data
Oct. 13, 2003 (SE) 0302691-1

(51) Int. Cl. B03C 3/155

(52) U.S. Cl. 96/52

(57) ABSTRACT

A device for cleaning of an air stream (40) from electrically charged particles (aerosols), the air stream passing through the device, the device including at least two electrode elements (20, 21) that are arranged in planes parallel to each other and at a gap distance (d) between adjacent electrode elements (20, 21). The electrode elements (20, 21) are connected to a respective terminal of a high voltage source, and spacers (11) are provided between adjacent electrode elements (20, 21). It is significant of the device that the spacers (11) constitute electrically insulating material, through which material the air stream may pass, and that the spacers (11) are arranged in such a way that all air transport through the device must pass through the spacers (11).

### TECHNICAL FIELD OF THE INVENTION

The present invention relates to a device for cleaning of an air stream from electrically charged particles (aerosols), said air stream passing through the device, said device comprising at least two electrode elements that are arranged in planes parallel to each other and at a gap distance between adjacent electrode elements, that the electrode elements are connected to a respective terminal of a high voltage source, and that spacers are provided between adjacent electrode elements.

### PRIOR ART

Two techniques are used today to clean air from particles and aerosols (very small particles):

Mechanical filters constituting thin fibres of glass, synthetics or cellulose material: In order to catch small particles very fine fibres are necessary. Via the Manufacturing process the synthetic fibres may be given a certain electrostatic charge that especially when the filter is new improves the filtering of small particles.

Electrostatic filters, so-called two-step electro filters, comprise an ionizing chamber in which the particles carry an electric charge and a so called precipitator. The charged particles pass the precipitator in the air stream and are deposited on the electrodes of the precipitator.

Mechanical filtering is the number one filtering method in the world. Its primary drawback is that proper filtering demands fine filters that create high air resistance (so called pressure drop). High pressure drops bring about high energy costs and also result in a high sound level from the fans.

The use of higher filter classes often brings about that such a filter must be protected from heavy dust deposit by means of a filter with a lower filter class. Naturally, the pressure drop increases to a corresponding degree.

The other way around electrostatic filters have a more cost efficient filtering compared to the mechanical filters, since they work at considerably lower air resistance. Recent development of the electro filter technique, described in Swedish patent no. 0103684-7, has to a substantial degree improved the traditional electro filter technique. However, certain drawbacks are still present.

In connection with higher air velocity through the filter (1-4 m/s), e.g. in ventilation ducts, heavy dust has a tendency to migrate through the filter and follow the air stream.

A further disadvantage in connection with higher air velocities is that the electrodes of the precipitator must be arranged at a gap distance of some millimeters between adjacent electrode elements in order to achieve the desired separation result. This brings about that heavy dust easily surrounds the inlet area of the precipitator and the operating parameters are negatively affected to a considerable degree.

In order to separate particles from combustion engines ceramic filters are normally used. These filters have extremely large air resistance which means increased wear of the engines and increased fuel consumption.

From WO 87/02274 A1 an electrically stimulated filter is previously known. This filter comprises electrode elements that are perforated. The air stream direction is generally transverse to the planes that the electrode elements are located in. Between the electrode elements a filter medium is provided, said filter medium normally constituting glass fibre. The filter also comprises means for charging of the air that will pass the filter.

From EP 0 808 660 A1 an electrostatic dust separator is previously known, said separator comprising a unit for corona discharge and a unit that creates an electric field. The last mentioned unit comprises electrode elements that are arranged at a certain mutual distance. In one embodiment (working example 6; FIG. 10) of the dust separator according to EP 0 808 660 A1 a non-conductive, dielectric element is provided between the electrode elements, said dielectric element may be designed as a net of polypropylene that is received in a V-shaped house, likewise of polypropylene. In this connection it should be pointed out that the non-conductive, dielectric element does not constitute a spacer between the electrode elements. By spacer it should be understood an element that keeps the electrode elements at a certain mutual distance.

### OBJECTS AND FEATURES OF THE INVENTION

A primary object of the present invention is to present a new type of particle filter that is characterized by a relatively seen very low and almost constant pressure drop in connection with very high separation ability of both large and micro sized particles as well as a relatively seen substantial increase of the dust collection ability.

A further object of the present invention is to present an embodiment of a filter for cleaning of particles in combustion exhaust gases from motor driven vehicles.

At least the primary object is realized by means of a particle filter that has been given the features of the appending independent claim 1. Preferred embodiments of the invention are defined in the dependent claims.

### BRIEF DESCRIPTION OF THE DRAWINGS

Below preferred embodiments of the present invention will be described, reference being made to the accompanying drawings, where:

FIG. 1a shows a perspective view of a portion of an air stream duct, in which a particle filter according to the present invention is provided;

FIG. 1b shows a perspective view of an electrode element that is part of the particle filter in FIG. 1a, said electrode element being equipped with spacers; and

FIG. 2 shows a perspective view of two electrode elements with different configurations of current wire lines.

### DETAILED DESCRIPTION OF PREFERRED EMBODIMENTS OF THE INVENTION

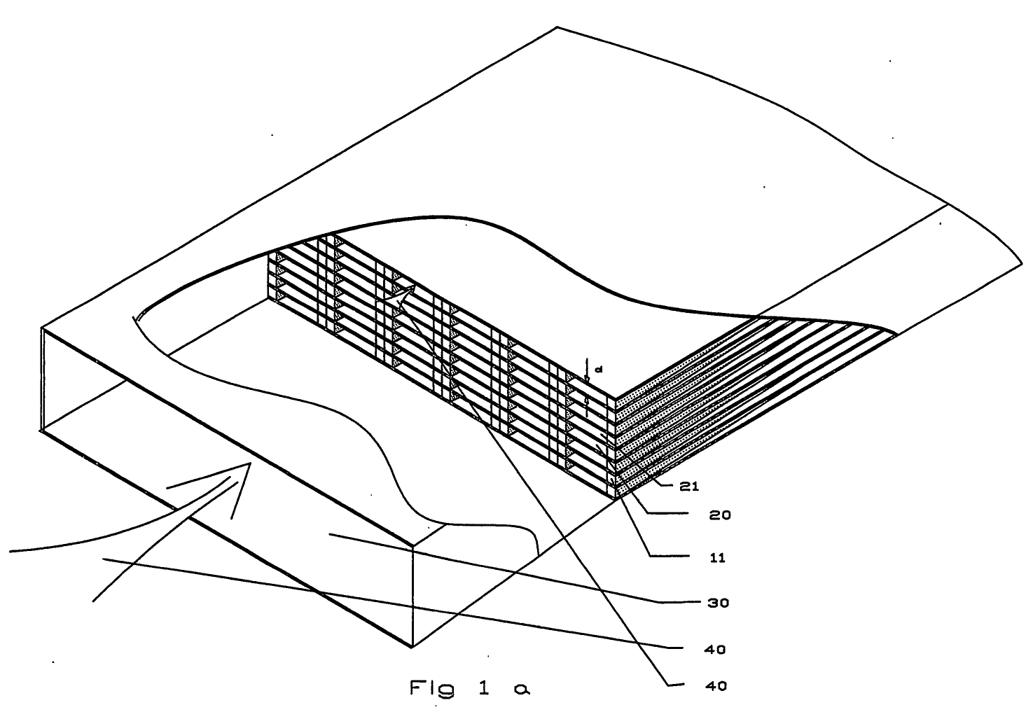

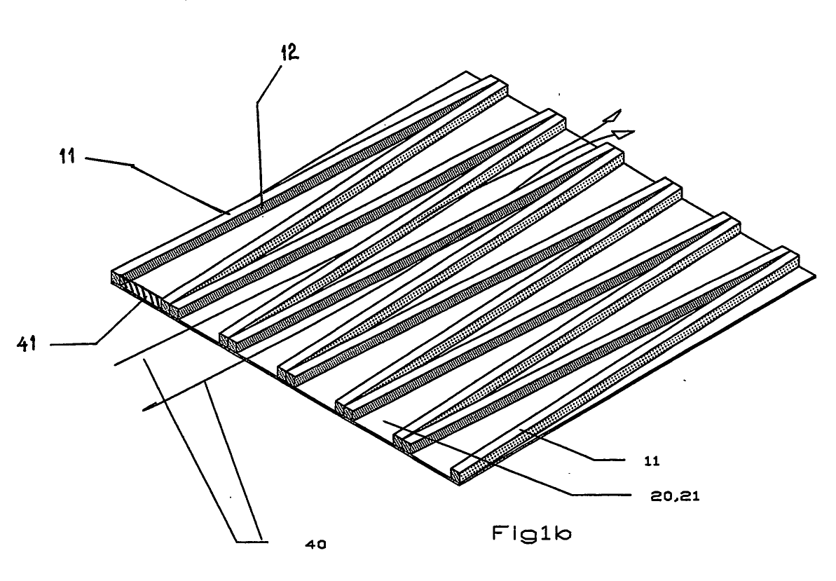

As is evident from FIG. 1a two groups of electrode elements 20, 21 are arranged in an air stream duct 30, said electrode elements 20, 21 being arranged alternately in respect of an adjacent electrode element, i.e. one electrode element 20 from one group has on both sides electrode elements 21 from the other group. The electrode elements 20, 21 are arranges in planes that are parallel to each other and at a gap distance “d” from each other. Between the electrode elements 20 and 21 respectively spacers 11 are arranged, see also FIG. 1b. Normally, a cover is provided around the “package” that is formed by the spacers 11 and the electrode elements 20, 21. This cover surrounds the spacers 11 and the electrode elements 20, 21 on the sides having an extension in the longitudinal direction of the air stream duct 30. For clarity reasons this cover is not shown in FIG. 1b. The cover is designed from an electrically insulating material, e.g. plastic. The cover, the electrode elements 20, 21 and the spacers 11 define a cartridge that for instance may be installed in an air stream duct.

The spacers 11, shown in FIG. 1b, are preferably arranged as V-shaped configurations of bars or strips.

Preferably, the spacers 11 are of the same material that is used in mechanical filters (glass fibre, synthetic fibre or plastic fibre), foamed plastic or ceramic structures with high-temperature resistance. Regardless of the material that is used, said material must be permeable to an air stream 40 and electrically insulating.

As is evident from FIG. 1b the spacers 11 contact the electrode elements 20, 21 along their entire length. Normally, the spacers 11 are glued to one of the electrode elements 20, 21, normally the lower electrode element. In FIG. 1b only the lower electrode element 20, 21 is shown, however the spacers 11 are in contact also with the upper electrode element 20, 21. Normally, there is no gluing against the upper electrode element 20, 21.

In the shown embodiment the electrode elements 20 and 21 respectively are made from a cellulose based material, preferably cardboard and coated with a micrometer thin plastic film in order to protect the material from moisture. Also the edge sections of the electrode elements are encased, e.g. by hot melt adhesive or tape, in order to prevent moisture penetration.

In connection with ventilation or corresponding areas of use it is a clear advantage that the electrode elements 20, 21 constitute material with very high resistivity and of disposable type as for instance cellulose material. In the latter case disc shaped electrodes from plastic coated paper are especially suitable.

The electrode elements 20 and 21 respectively are in a previously known way connected to a respective terminal of a high voltage source (not shown in the figures), whereby an electrostatic field is present in the gap between the adjacent electrodes 20, 21.

As is shown in FIG. 1b the air stream 40 is forced to pass through the spacers 11 that create the V-shaped spacing formations. The result of this is that the velocity of the air stream 40 through and adjacent to these formations slows down several times compared to the velocity of the air stream in the air stream duct 30. By 41 in FIG. 1b has been designated the available inlet area of the air stream 40 between two adjacent electrode elements 20, 21 (only the lower is shown) and two adjacent spacers 11. By 12 has been designated the available passage area of a spacer 11, said passage area 12 extending along the entire length of the spacer 11. In this connection it should be considered that the total passage area for the air between two cooperating spacers 11 in V-formation is twice the passage area 12 that one spacer 11 has. As regards the present invention the passage area 12 of the two spacers 11 should be twice, preferably 6-30 times, as large as the available inlet area 41 for the air stream when passing between two adjacent electrode elements 20, 21.

By the substantial velocity drop of the air stream 40 the separation of larger and micro sized particles on the surfaces of the electrode elements 20 and 21 respectively increases several times, also at a relatively seen very large gap distance “d” between the adjacent electrode elements 20, 21. As regards the gap distance “d” it should preferably be in the interval 3-30 millimeter. However, both larger and smaller gap distances “d” are possible within the scope of the invention.

A separation ability of more than 85% was achieved in lab tests with spacers 11 manufactured from coarse filter media, corresponding to filter class G3, gap distance “d” between the electrodes 20, 21 of about 15 mm and air velocity corresponding to 2.4 m/s in the air stream duct 30.

The spacers 11 may of course constitute the same material that is used in higher classes of mechanical filters, e.g. fibre filters. Regardless which material that is used it should in itself be electrically insulating. For instance glass filter material or synthetic filter material fulfills these demands. Also ceramic filters are of electrically insulating material.

Swedish patent no. 0103684 presents a description of particles separators designed from paper, the energizing of the electrode elements is arranged by means of semi-conductive coating printed on paper in the shape of thin current lines. Such energizing is also a preferred embodiment in connection with the present invention in case the electrode elements 20, 21 constitute cellulose material. In this connection it should be pointed out that the device according to the present invention may be part of both a precipitator and a particle separator according to Swedish patent no. 0103648-7.

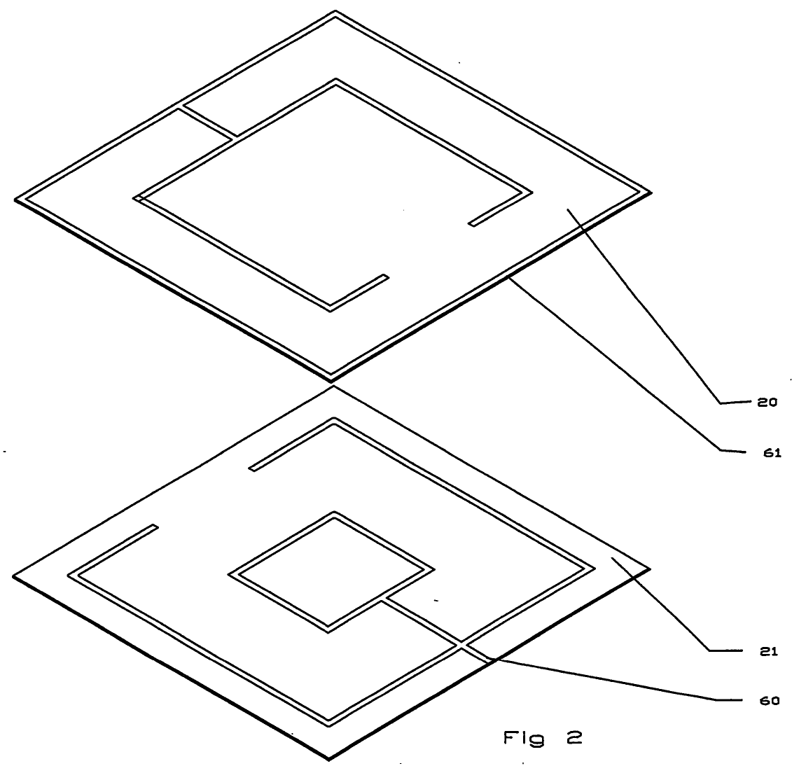

FIG. 2 shows a preferred embodiment of current lines 60, 61 that are pending when using the principle according to Swedish patent no. 0103684-7. In the shown example the electrode elements 20 are preferably connected to earth while the electrode elements 21 are energized. Of course the current line pattern may be designed in a different way, however the current lines 60, 61 on respective electrode element 20, 21 should the arranged at a distance to each other that is larger than the gap distance “d” between the electrode elements 20, 21.

The charging of particles and aerosols, before they in the air stream pass between the electrode elements 20, 21, is effected upstream, seen in the direction of the air stream through the device, in a previously known way. Normally, this is effected by having an ionizing unit installed in the air stream duct upstream the device according to the present invention.

The air stream through the device may be initiated by means of fans or natural draught or in a different way, e.g. by having the device mounted in the exhaust duct of a combustion engine.

In the latter case the electrodes 20, 21 and the spacers 11 should be made from a material that resists high temperature. It is preferred that the spacers constitute ceramic (glass) material and that the electrode elements constitute sheet metal.

The particle filter according to the present invention has excellent separation parameters also at a relatively seen very large gap distance between the electrodes 20, 21. This brings about that considerable amounts of dust may be gathered on the electrode elements 20, 21 without the risk of flash over between the electrode elements 20, 21. When used in extreme environments, that usually demand guarantee that no particles may pass the filter, the spacers 11 may constitute very high classes of known mechanical filters or known filters for cleaning exhaust gases from particles. The initially high pressure drop through the device may be kept at a constant level instead of increasing when the precipitated amount of dust increases.

It should especially be pointed out that the spacers 11 included in the device functions on one hand as mechanical filters and on the other hand as spacers. It should also be pointed out that the spacers 11 preferably have a certain transverse extension relative to the air stream direction. Within the scope of the present invention the lateral extension of the spacers 11 may be relatively seen small, which means that the spacers 11, and thus also the electrode elements 20, 21, may have a length of several meters.

### FEASIBLE MODIFICATIONS OF THE INVENTION

In the embodiment shown in FIG. 1a the electrode elements 20, 21 constitute cellulose material. Within the scope of the present invention also other materials may be used, e.g. plastic with antistatic or semi-conductive coating or nature or conductive materials, e.g. aluminium plates or the like. In case filtering of particles from exhaust gases is to be effected all material should be heat resistant.

As regards the spacers 11 included in the device according to the present invention they should belong to all established filter classes, i.e. rough filters, fine filters, micro filters and HEPA filters.

The spacers of the present invention may also constitute relatively thin strips that are oriented standing and equipped with a fine perforation, i.e. the openings that create the perforation are proportionately small.

In the embodiment described above the air passes through a spacer 11 and then continues in the air stream duct 30. Within the scope of the present invention it is also feasible that there are several sets of spacers arranged one after the other in the direction of the air stream. This means that the air must bypass two or more spacers that is favorable as regards the separation on the electrode elements since the velocity between two consecutive spacers is extremely low.

In connection with the embodiment described above it is stated that the spacers 11 may be glued to the lower electrode element 20, 21. Within the scope of the present invention it is also feasible with alternative ways to connect the spacers 11 with the electrode elements 20, 21. In exemplifying and not restricting purpose it may be mentioned that the spacer on one side may be equipped with a two sided adhesive tape.

In the embodiment described above all spacers 11 included in the V-formation are permeable to air. However, within the scope of the present invention it is also feasible that only every second spacer is permeable to air. In such a case the spacers that are not permeable to air may have an extension straight in the direction of the air stream while the permeable spacers have a certain lateral longitudinal direction relative to the air stream.

It may be suitable that the different groups of electrode elements 20 and 21 respectively are displaced somewhat relative to each other in the direction of the air stream. Hence, the projecting portions of one group of electrode elements may easily be electrically connected to each other.

1. Device for cleaning of an air stream (40) from electrically charged particles (aerosols), said air stream passing through the device, said device comprising at least two electrode elements (20, 21) that are arranged in planes parallel to each other and at a gap distance (d) between adjacent electrode elements (20, 21), that the electrode elements (20, 21) are connected to a respective terminal of a high voltage source, and that spacers (11) are provided between adjacent electrode elements (20, 21), characterized in that the spacers (11) constitute electrically insulating material, through which material the air stream may pass, and that the spacers (11) are arranged in such a way that all air transport through the device must pass through the spacers (11).

2. Device according to claim 1, characterized in that the spacers (11) that belong to one gap are arranged in V-shape.

3. Device according to claim 1, characterized in that the spacers (11) along their entire length abut to adjacent electrode elements (20, 21).

4. Device according to claim 1, characterized in that the spacers (11) generally extend along the direction of the air stream through the device.

5. Device according to claim 1, characterized in that the spacers (11) constitute glass fibre or synthetic fibre.

6. Device according to claim 1, characterized in that the spacers (11) constitute foamed plastic.

7. Device according to claim 1, characterized in that the gap (d) is in the interval 3-30 mm.

8. Device according to claim 1, characterized in that the passage area (12) of two cooperating spacers (11) should be at least double the available inlet area (41) of the air stream when it passes between two adjacent electrode elements (20, 21).

9. Device according to claim 1, characterized in that the spacers (11) are manufactured from materials having high heat resistance, e.g. ceramic materials.

10. Device according to claim 9, characterized in that also the electrode elements (20, 21) constitute heat resistant material, e.g. aluminium.

11. Device according to claim 1, characterized in that the electrode elements (20, 21) consist of a high resistive material or have a coating of high resistive material.

12. Device according to claim 11, characterized in that the electrode elements (20, 21) constitute cellulose material.

13. Device according to claim 1,
characterized in that the spacers (11) and the electrode elements (20, 21) are surrounded by a cover on the sides having an extension in the direction of the air stream.

14. Device according to claim 2, characterized in that the spacers (11) along their entire length abut to adjacent electrode elements (20, 21).
